(19) United States
(12) Patent Application Publication
(10) Pub. No.: US 2017/0008721 A1
(43) Pub. Date: Jan. 12, 2017

(54) IN SITU CHOPPING CUT AND CONVEYOR MACHINE AND METHOD OF USING SAME

(71) Applicant: SHANGHAI KINBIO TECH CO., LTD., Shanghai (CN)

(72) Inventors: Zhongren Zhou, Shanghai (CN); Jie Jiang, Shanghai (CN); Keren Zhou, Shanghai (CN)

(21) Appl. No.: 15/113,045

(22) PCT Filed: Mar. 12, 2015
(86) PCT No.: PCT/CN2015/074073

§ 371 Date: Jul. 20, 2016

(30) Foreign Application Priority Data
Jan. 21, 2014 (CN) 201410027453.3

(51) Int. Cl. B65H 35/00; B65H 43/04; B26D 7/08; B65H 29/12; B26D 1/06; B26D 5/00

(52) U.S. Cl. CPC B65H 35/0086; B26D 1/065; B26D 5/007; B26D 7/08; B65H 29/12; B65H 43/04; B65H 2301/51532; B65H 2404/261

(57) ABSTRACT

A chopping cut mechanism comprising a first driving device and a chopping cut device, the chopping cut device comprises an upper blade and the first driving device drives the upper blade to carry out reciprocating motion. The upper blade having a compaction component and the compaction component comprises a compaction part which is not lower than the upper blade edge line. A first conveying mechanism, wherein the first conveying mechanism comprises: a second driving device and a first conveying device, the second driving device drives the first conveying device for directional transport, the first conveying device is located below the upper blade.

### SUMMARY

According to one aspect, a chopping cut mechanism comprising a first driving device and a chopping cut device, the chopping cut device comprises an upper blade and the first driving device drives the upper blade to carry out reciprocating motion. The upper blade having a compaction component and the compaction component comprises a compaction part which is not lower than the upper blade edge line. A first conveying mechanism, wherein the first conveying mechanism comprises: a second driving device and a first conveying device, the second driving device drives the first conveying device for directional transport, the first conveying device is located below the upper blade.

According to another aspect, a method of using the in situ chopping cut and conveyor machine to cut, locate, and convey material, the method comprising compacting the material to be cut at a conveyor surface of a first conveying device through a compacting component of the in situ cut and conveyor machine, driving the first conveying device by the second driving device to carry out directional conveying of the clamped and cut material, and conveying the cut material one by one to a setting location.

### BRIEF DESCRIPTION OF THE DRAWINGS

Reference will now be made to the attached drawings, when read in combination with the following specification, wherein like reference numerals refer to like parts throughout the several views, and in which:

FIG. 1 is a three-dimensional schematic diagram of the in situ chopping cut and conveyor machine, namely example 1 of an embodiment of the invention.

FIG. 2 is a schematic diagram of disassembly of the chopping cut mechanism, which is example 1 as shown in FIG. 1 of an embodiment of the invention.

FIG. 3 is a schematic diagram of the chopping device, which is example 1 as shown in FIG. 1 of an embodiment of the invention.

FIG. 4 is a schematic diagram of the upper blade, which is example 1 as shown in FIG. 1 of an embodiment of the invention.

FIG. 5 is a front schematic diagram of example 1 as shown in FIG. 1 of an embodiment of the invention.

FIG. 6 is a schematic diagram of a first conveying mechanism, which is example 1 as shown in FIG. 1, according to one embodiment.

FIG. 7 is a schematic diagram of the chopping cut mechanism, which is example 2 of this invention, according to one embodiment.

FIG. 8 is a schematic diagram of the first conveying mechanism, which is example 3 of an embodiment of the invention.

FIG. 9 is a schematic diagram of the first conveying mechanism, which is example 4 of an embodiment of this invention.

FIG. 10 is a three-dimensional schematic diagram of the in situ chopping cut and conveyor machine, namely example 5 of an embodiment of the invention.

FIG. 11 is a schematic diagram of disassembly of a second conveying mechanism, which is example 5 as shown in FIG. 10 of an embodiment of the invention.

FIG. 12 is a detail schematic diagram of the second conveying mechanism, which is example 5 as shown in FIG. 10 of an embodiment of the invention.

FIG. 13 is a schematic diagram of sectional view A, which is example 5 as shown in FIG. 10 of an embodiment of the invention.

FIG. 14 is a rear-view diagram of the second conveying mechanism in example 5 which is also shown in FIG. 10. FIG. 14 additionally illustrates the third driving device configured to drive the upper and lower driving pulleys, according to one embodiment.

FIG. 15 is a cross section of a main portion of existing paper cutting machine technology (Japan Patent JP3113949), the operating state of moving parts is shown.

FIG. 16 is a longitudinal section drawing of existing paper cutting machine technology (Japan Patent JP3113949), the structure of a support component is shown.

FIG. 17 is an external structure of the driving mechanism in example 5, according to one embodiment.

FIG. 18 is an internal structure of the driving mechanism in example 5, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Embodiments of the invention relate to a paper cutting machine, specifically relates to a in situ chipping cut and conveyor machine with positioning and conveying method, which is used for chopping cut into strips for diagnostic test paper.

There are two current methods of the current production process of test paper, one is rolling cut, another is chopping cut, in the existing conventional cut production, the diagnostic test paper sheet (strip sheet) need chopping cut into strips (for example: length×width for 60 mm*5 mm), then the test paper strip falls down from the cutting off position along the surface of the lower cutter, and it drops into to a container, through manual classification of the test paper quality, the finished strip manually placed into a plastic card.

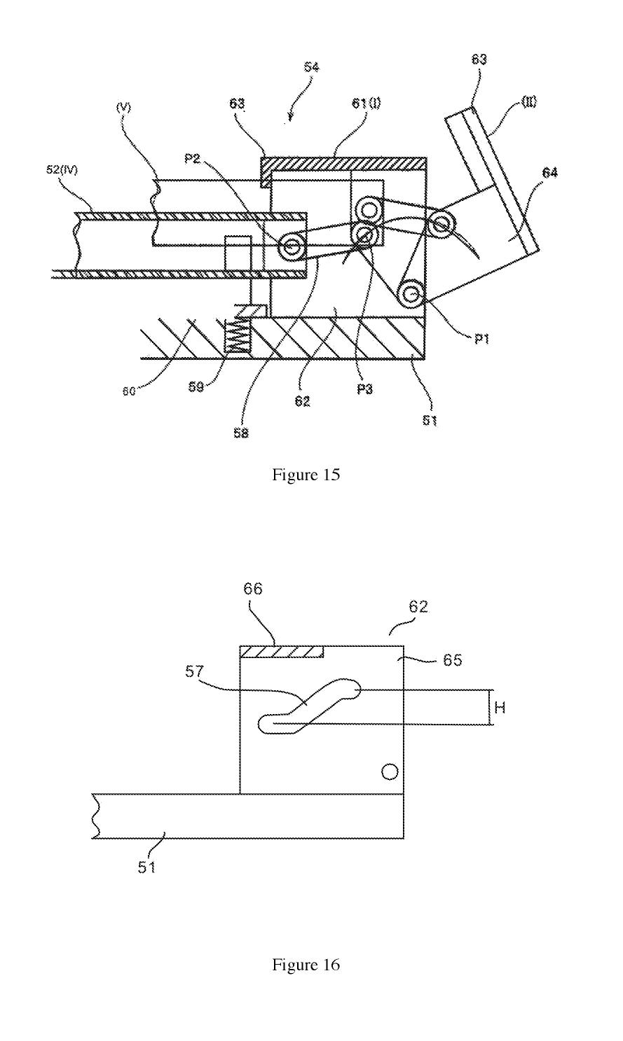

Both above two methods have the defects that the test paper strip turns over, and cannot accurately be positioned in the production process. Japanese patent JP3113949 provides a cutting machine with paper pressing unit, as shown in FIG. 15. Two ends of the rail 52 can move vertically through a pair of fixed support components on the bottom plate 51. At the bottom of the rail 52, the pressure board is independent of the rail 52, so that the pressure board is set to be installed in the vertical direction, can move to the bottom plate 51. In addition, the slide device (not shown) is installed on the rail 52, and the rotating blade is installed on the sliding device. The guide hole 57 is in the inside of the pairs of each support components 54, as shown in FIG. 16, the two ends of 52 are supported by 54, so that rail 52 rises or falls through the pin 52 which is inserted into guide hole 57 and rail 52.

As shown in FIG. 15, one of the supporting parts 62 comprises of a movable part 61 and a fixed part 54. For part 61, the tongue shape part is integrally molded and is approximately perpendicular to cover 63, the tongue shape part 64 is fixed to the fixing components 62, to make it pivoting through the pin P1. The rail 52 and the movable component 61 are connected via a connecting component 58 (connecting mechanism) jointly with the pin P2 and pin P3.

As shown in FIG. 16, the fixing component 62 has a door shape. Wherein, two side plates 65 formed integrally through the ceiling 66, and is fixed on the bottom plate 51. The guide hole 57 formed in each side plate 65, the guide hole 57 inclined and forms a H drop, along with the an extension of the horizontal part bottom of bottom plate 51 is (holding device).

The pressure board is independent of the rail 52 and is arranged on the bottom plate 51, and is always pressed to the rail 52 through a compression spring 59 (push pressing device). In addition, the press plate is pressed vertically o the bottom plate 51 by a pressing pin arranged on the rail 52. The position of the pressing board is fixed by fixing the guide component 60 on the pressure board, the rail 52 is clipped in the middle.

If the movable component 61 is rotated clockwise around the pin P1 from state (I) to state (II), a pin P2 installed at the front end of the rail 52 can move along the guide hole 57, through the connecting component 58. At this point, the rail 52 moves to the right direction in FIG. 15, while maintaining a state of parallel to the base plate 51, rises up along the guide hole 57. When the rail 52 rises, depending on pushing force of compression spring 59, the guide component 60 guides the pressuring board to rise in the vertical direction until the blocking part contacts with the rail 52. As a result, a parallel gap is formed between the top surface of the bottom plate 51 and the pressuring board.

By inserting the paper to cut into the gap, it is easy to locate the chopping cut position along the edge of the pressing board. After the chopping cut position of the paper is matched, the movable component 61 rotates around the pin P1 in an anti-clockwise direction. At this point, the two ends of rail 52 move to the left and down in FIG. 15, by the pin P2 and pin P3 which pass through the guide hole 57.

Due to the vertical motion of rail 52, the rail 52 move horizontally between state (IV) and state (V). When the rail 52 moves horizontally, the front end of the pressing pin arranged on the rail 52 rubs against the top surface of the pressing board for the rail 52 and the pressing board are separated.

The horizontal movement of the pressing board is limited by fixing component 62 and the supporting component 54, so that the move direction of the pressing board is along the vertical direction of the bottom plate 51. When the pressing board moves downward, due to pressure the papers stack on the bottom plate 51 are kept between the pressing board and the bottom plate 51, so that the stacking state of the paper is not damaged.

According to the pressing paper unit revealed by the patent document, as mentioned above, even a lot of paper to be cut stacked on the bottom plate 51, the papers can also be easily located in chopping cut position. Meanwhile, it should prevent offsetting of paper to be cut, because the pressure board can only move along the vertical direction.

However, the rail 52 moves down together with horizontal movement, specifically by pressing the slider slides on the rail 52 without rotating the moving part 61, and the rail 52 is declined. In such a situation, the slider move horizontally to the paper to be cut, as the horizontal movement of rail 52.

The patent tries to provide a way to achieve accurate positioning of the cutting down paper through compaction of paper to be cut by pressing board, but without pressure the paper that placed on the bottom plate 51 is held at a final chopping cut position without the pressure of pressing board, and when the paper strip width is narrow, the paper strip may curl due to its scalability. Therefore, this way is not good for solving the difficult problem that the test paper strip turns over, cannot accurately positioned in production process.

At present, some manufacturers in the USA, also developed automatic chopping cut clamping machine, the test paper strip fed by the big plate of the machine, can be supported by metal surface before chopping cut, then is positioned and picked up by manipulator, when the test paper strip is cut, it can be absorbed by vacuum and be lifted upward, then moves along the same direction of the big plate feed and is directly transferred and plated to plastic card, finally returns for pick up again, if the test paper strip has defects, will be discarded.

The biggest problem of this way is when the strip is very narrow (such as less than 5 mm), the surface of the test paper strip is very small, it is difficult to positioned and picked up by manipulator, and the test paper of this width is currently the largest part of the production capacity. At the same time, when the test paper strip surface is relatively rough, it is difficult to positioned and picked up through vacuum adsorption.

To solve the problems of existing technology, embodiments of the invention are described herein.

Therefore, one of the technical problems to be solved is how to overcome the existing technology that the test paper strip turns over, cannot accurately positioned in production process, in order to achieve accurate selection of subsequent operation.

In addition, embodiments of the invention further solves the technical problem is how to realize the positioning and picking up of the test paper strip as the test paper strip is very narrow.

To solve the above technical problems, the present application puts forward with a technical scheme as follows: an in situ chopping cut and convey machine, it comprising, a chopping cut mechanism, wherein the chopping cut mechanism comprising, a first driving device and a chopping cut device, the chopping cut device comprises an upper blade, and the mentioned first driving device drives the upper blade to carry out reciprocating motion, the mentioned upper blade is provided with a compaction component, and the compaction component comprises a compaction part, which is not lower than the upper blade edge line; a first conveying mechanism, wherein the first conveying mechanism comprising, a second driving device and a first conveying device, the mentioned second driving device drives the first conveying device for directional transport, the mentioned first conveying device is located below the mentioned cutter.

According to an embodiment of the in situ chopping cut and conveyor machine recited in the present application, a material outlet is installed on the mentioned chopping cut mechanism, the lower edge of the material outlet is parallel to the inner section of the upper blade, the upper blade is fit with the lower edge during the chopping cut process.

According to an embodiment of the in situ chopping cut and conveyor machine recited in the present application, wherein the chopping cut mechanism comprising a feed device, the feed device comprises an upper feed roller and the lower feed roller, the lower feed roller is driven by a fourth driving device, the mentioned upper feed roller is installed on the turning frame, and the upper feed roller and the lower feed roller contacts, the upper feed roller can realize linkage by the rotation with the mentioned lower feed roller; the feed device also comprises two limiting block for limiting material to be cut, and the material is ready for exact chopping cut of chopping cut device through the fitting with the upper feed roller and the lower feed roller.

According to an embodiment of the in situ chopping cut and conveyor machine recited in the present application, wherein the first conveying device comprising the first conveyor belt, the first conveyor belt is installed on the lower edge side of the material outlet, and the conveying surface of the first conveying of the belt is not higher than the lower edge.

According to an embodiment of the in situ chopping cut and conveyor machine recited in the present application, the conveying surface of the first conveying belt is installed many blocks; the interval of these blocks is larger than the length of materials for chopping cut.

According to an embodiment of the in situ chopping cut and conveyor machine recited in the present application, on the side of first conveyor belt is installed with a recognition device, the recognition device can preset detection and recognition for cutting materials and make corresponding feedback information; the recognition device includes an image sensor, the image sensor induces the optical image information for materials to be chopping cut on the mentioned first conveyor belt and converts into usable output signal; the recognition device comprises a fiber optic sensor, the optical fiber sensor is installed on the side of first conveyor belt, the optical fiber sensor transmits the light from the block on the surface of first conveyor belt into the modulator through the optical fiber, the parameters to be measured interact with the light entered the modulation region, leading to changes in the optical properties of light, again through the optical fiber to the optical detector; after demodulation, parameter to be measured, in order to judge the position of undertaken chopping cut materials of the mentioned first conveying belt.

According to an embodiment of the in situ chopping cut and conveyor machine recited in the present application, the removing device is installed on the side of the first conveying belt, the removing device is set in the subsequent position of the mentioned identification device, according to the corresponding feedback information from the identification device, the materials to chopping cut can be removed.

According to an embodiment of the in situ chopping cut and conveyor machine recited in the present application, a correcting device is installed on the side of the mentioned first conveying belt; the correcting device includes limiting plate, rotary rod and correcting block, the correction block can reciprocate on the rotary rod.

In addition, embodiments of the invention also provides a method of using the above in situ cutting conveyor for cutting the material and positioning the conveying, which comprises the following steps:

the material to chopping cut is compacted conveyor surface of the first convey through the compacting component of the in situ cut and convey machine; the second driving device drives the first conveying device to carry out directional conveying of the clamped chopping cut material; the chopping cut material is conveyed one by one to setting location.

According to an embodiment of the method recited in the present application, according to the preset information, the recognition device can detect and identify the materials for chopping cut, then feedbacks the corresponding information to the removing device, the material for chopping cut will be removed by the removing device, as it cannot meet the specifications.

To solve the above technical problems, the present application puts forward with a technical scheme as follows: an in situ chopping cut and convey machine as is mentioned above, it also comprising, a second conveying mechanism, the second conveying mechanism is installed at the end of the first conveying mechanism, and the second conveying mechanism comprises a third driving device and the second conveying device, the second conveying device comprises an upper conveying belt and lower conveyor belt, the upper conveying belt is fit with lower conveyor belt; the third driving device drives upper conveying belt and lower conveying belt to realize directional movement.

According to an embodiment of the in situ chopping cut and conveyor machine recited in the present application, the lower conveyor belt partially fit with the upper conveying belt, part of the lower conveyor is anterior with the setting of the upper conveying belt.

According to an embodiment of the in situ chopping cut and conveyor machine recited in the present application, the upper conveying belt, is driven by driving pulley for upper conveying belt, its end is provided with a driven pulley for upper conveying belt, its middle part is provided with a upper conveying belt tension pulley and the upper conveying belt elastic pulley; the lower conveying belt, is driven by driving pulley for lower conveying belt, its end is provided with a driven pulley for lower conveying belt, its middle part is provided with a lower conveying belt tension pulley; the driving pulley for upper conveying belt is on the left side of driving pulley for lower conveying belt and keeps a distance, the test paper strip with different thickness can be clamping conveyed, there is enough gap is larger than the largest thickness test paper strip; In front of the driven pulley for upper conveying belt, the adjustable pressure pulley is installed. Under the press of pressing block, the pressure to the upper conveying belt can be adjusted, pressure of conveying belt, so the clamping force of outputting end and test paper strip can be adjusted during outputting process.

According to an embodiment of the in situ chopping cut and conveyor machine recited in the present application, the roller is installed on the lower stacked part of the upper conveying belt and the lower conveying belt, and several rollers is arranged along the arc, so the stacked part of the upper conveying belt and the lower conveying belt can be conveyed downward along the arc.

According to an embodiment of the in situ chopping cut and conveyor machine recited in the present application, the finishing mechanism for outputting test paper strip device is installed at the end of the second conveying device, the elastic adjusting block is used to adjust lateral position with the second conveying device at the slit of the end finishing block, it is flexible, when the test paper outputs, the elastic adjusting block can extrude the test paper strip, so that the linear is better during output process, to ensure that the assemblage of test paper strip is more accurate.

According to an embodiment of the in situ chopping cut and conveyor machine recited in the present application, the third driving device of the second conveying mechanism, is also provided with a double-sided tooth synchronous belt, the driven pulley and the driven pulley is driven, the rotation direct is opposite, the tensioning pulley tensions the double-sided tooth synchronous belt, the driven pulley drive the upper conveyor belt drive pulley and the driven pulley drive the lower conveyor belt drive pulley.

According to an embodiment of the in situ chopping cut and conveyor machine recited in the present application, the upper blade is arranged on the expansion bracket, with the drive of the first drive device and the upper blade completes the chopping cut with up and down reciprocating; or, the upper blade is arranged on the slide rod, and is driven by the first drive device, the upper blade completes the chopping cut with up and down reciprocating on the slide rod.

According to an embodiment of the in situ chopping cut and conveyor machine recited in the present application, the first conveying device includes the rail, slide block and conveying plate, the slide block and rail is fit and is under the action of the second driving device, can reciprocate along the rail, the slide block is provided with a small push block, the chopping cut material is compacted on the conveying plate, and then through a small push block to carry out directional conveying of the clamped chopping cut material.

According to an embodiment of the in situ chopping cut and conveyor machine recited in the present application, the first conveying device includes the rail, slide block and conveying plate, the slide block and rail is fit and is under the action of the second driving device, can reciprocate along the rail, the slide block is provided with a small push block, the chopping cut material is compacted on the conveying plate, and then through a small push block to carry out directional conveying of the clamped chopping cut material.

In addition, embodiments of the invention also provides a method of using above in situ chopping cut and conveyor machine for chopping cut the material together with positioning and conveying, which comprises the following steps: the materials for chopping cut is compacted to the conveying surface of the first conveying device through compacting by compaction part of the in situ chopping cut and conveyor machine; the second driving device drives the first conveying device to carry out directional transmission of the materials for chopping cut; the materials for chopping cut are conveyed one by one to setting position.

In addition, embodiments of the invention also provides a method of using the above in situ chopping cut and conveyor machine for chopping cut material together with positioning and conveying, which comprises the following steps: the materials for chopping cut is compacted to the conveying surface of the first conveying device through compacting by compaction part of the in situ chopping cut and conveyor machine; the second driving device drives the first conveying device to carry out directional transmission of the materials for chopping cut; the third driving device drives the materials for chopping cut to carry out the directional movement, which are clamped by the upper conveying belt and the lower conveying belt; the materials for chopping cut are conveyed one by one to setting position.

According to an embodiment of the in situ chopping cut and conveyor machine recited in the present application, the recognition device detects and identifies the materials for chopping cut and feedbacks the corresponding information to removing device according to the preset information, the materials not meet the specifications can be removed.

Embodiments of the invention have the following beneficial effects: the big plate conveys forward with needed width, during the cutting process, the position of materials for chopping cut inclines similar to the inclination of upper blade, also causes lateral tiny movement, but after cutting off, it is flat pressed by blade fixture and is placed on the next adjacent blade line conveying device surface, along the right angle direction with the feed direction of big plate, the conveying device enable the test paper for horizontal movement, when the movement is larger than the material length, the conveying device and plate feed in a direction at right angles to the direction to will strip transverse moving over to cut the material length distance, chopping machine immediately re transported out of the need of width of the strip again cut and conveying device repeatedly strip lateral movement. Cutting of the transverse movement of the material can be carried through the conveyor device to carry the cutting of the material movement to achieve, but also through the cutting of a tip of the material to promote. Therefore, the width of the test paper and the roughness of the upper surface is no longer the main limiting factor. Having the quality defects of cut material will be in the process of transverse mobile for recognition and sensing and kick it out, cut the material along the direction parallel to the fine position in the lateral movement of the process can be adjusted by mechanical rectification. Using the in situ cut and conveyor machine can be accurate to cut material positioning, chooses. At the same time, the width of the cut material and surface roughness of is no longer the main limiting factors, cut the material through the conveying belt clip to oblique angle conveyor, one-way mobile, there is no repetitive movements of the manipulator, can greatly improve the working efficiency.

### Example Implementation Method

Below is a detailed description of the embodiments of the invention, the implementation example is shown in the drawings, the same or similar labels that from the beginning to the end indicates the same or similar elements or the same or similar functions components. The examples that is descripted by reference diagram are illustrative only for the interpretation of the embodiments of the invention, and should not be read as limiting embodiments of the invention in any way.

Among the description of various embodiments of the invention, the terms “within”, “outside”, “up”, “down”, “front”, “rear” and “end” indicate the direction or position basing on the figure expression, is only in order to facilitate the description of the embodiments rather than requiring the embodiments be in certain range to construct and operate.

### EXAMPLE 1

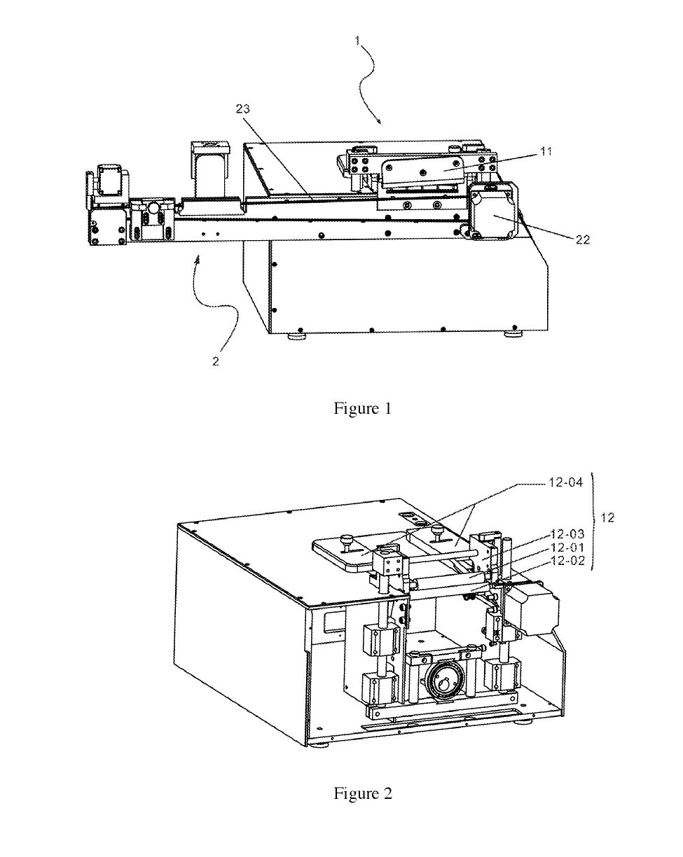

The following reference FIG. 1 describes an embodiment of the present invention in situ chopping cut and conveyor machine.

As shown in FIG. 1, the in situ chopping cut and conveyor machine includes the chopping mechanism 1, which is part of the existing paper cutter body, the chopping cut mechanism 1 includes the first driving device (not marked) and chopping cut device 11; in the example, the chopping cut device 11 includes the upper blade, and the first driving device drives the upper blade for updown reciprocating movement to achieve the chopping cut for materials to be cut, which is the machining process of material by chopping cut method in example 1.

By FIG. 1, in situ chopping cut and conveyor machine also comprises a first conveying mechanism 2, which includes the second driving device 22 and the first conveying device 23, the second driving device 22 is capable of driving the first conveying device 23 for directional conveying, and the first conveying device 23 is below the upper blade. So, the cutting off materials are placed on the conveying surface of the first conveying device 23, the directional conveying of materials is realized.

As shown in FIG. 2, the materials to be cut are conveyed through the feed device 12, see FIG. 2, the feed device 12 includes the upper feed roller 12-01 and the lower feed roller 12-02, the latter one is driven by the fourth driving device (not marked), the upper feed roller 12-01 is fixed on the overturning frame 12-03, and the upper feed roller 12-01 touches the lower feed roller, so that the upper can achieve linkage with the rotation of the lower feed roller.

For the chopping cut materials, the left and right limiting block 12-04 can limit the materials to be cut, then and materials to be cut is ready for precision cut of the chopping cut device 11 through the laminating of the upper feed roller and the lower feed roller.

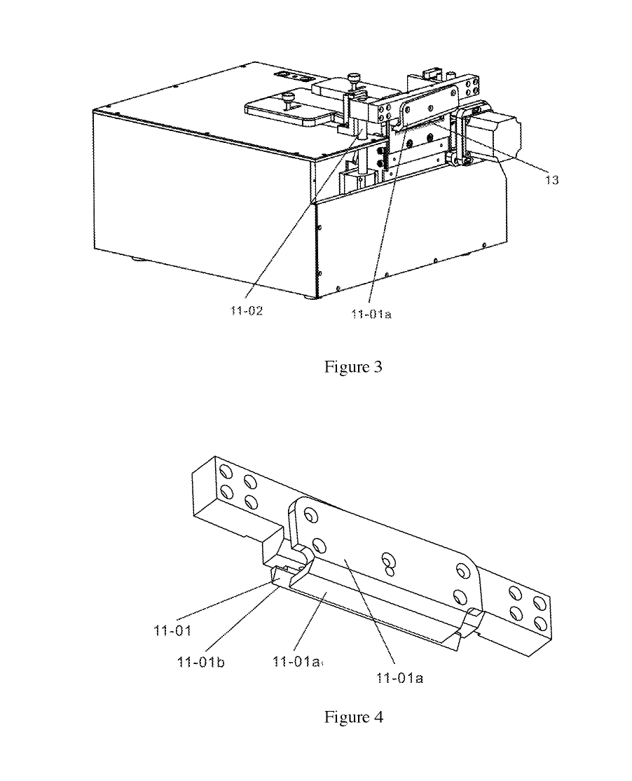

Take a closer look at FIG. 3 and FIG. 4, the upper blade 11-01 is set on the telescopic frame 11-02, with the driving of the first driving device, the upper blade 11-01 moves for updown reciprocating ; the compacting component 11-01a is arranged on the upper blade 11-01, including compacting part 11-01a₁, which is higher than or parallel to the upper blade edge line 11-01b, in chopping cut process, the compacting component 11-01a₁ can compact and position the chopping cut materials with the cutting off of the upper blade 11-01, by doing so, avoid the emergence of the paper jumping and turning. In chopping cut process of the upper blade 11-01, the lower edge of material outlet 13 is parallel to the inner section of the upper blade 11-01, and also laminate during the dropping cut, in fact plays a role similar with the lower blade or Chopping board, convenient for materials for chopping cut by the upper blade 11-01.

Preferably, there is a certain angle between the lower edge of material exports 13 and the upper blade 11-01, convenient for materials for chopping cut by the upper blade 11-01.

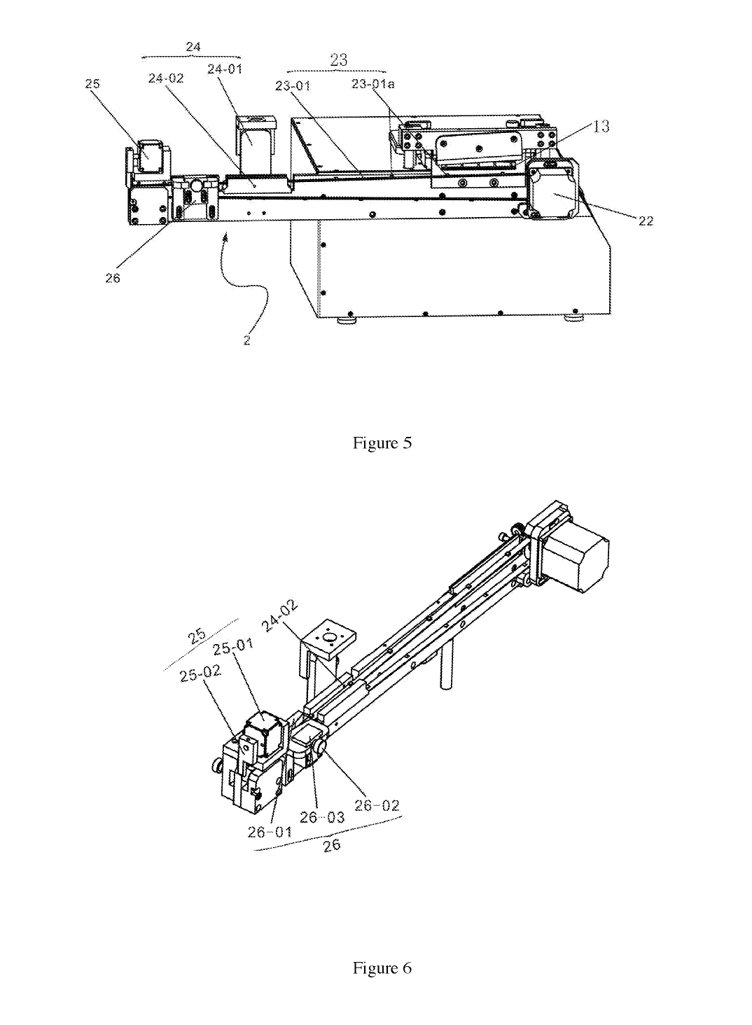

See FIG. 5, in this example, the first conveying device 23 locates below the upper blade 11-01, exactly the first conveying device 23 includes the first conveying belt 23-01, the includes a first conveying belt 23-01 the conveyor 23-01 forms a cycle conveying route through surrounding corresponding driving pulley (not marked) the second driving device drives the first conveying belt 23-01 for directional material conveying, meanwhile, the first conveying belts 23-01 is set on the side of lower edge of material export, the conveying surface of the first conveying belt 23-01 is lower than lower edge of material export of conveying the export 13, which can ensure the chopping cut materials to fall into proper position accurately on the surface of the first conveying belt 23-01.

Of course, in this example, several block are set on the conveying surface of the first conveying belt 23-01, any distance between two blocks is larger than the materials length for chopping cut, so the lateral movement of the chopping cut materials can be achieve through the conveying device carrying cut material movement, or by pushing of the chopping cut materials end.

In this example, for precise select of chopping cut materials which meet the standards, the recognition device 24 is set on the side of the first conveying belt 23-01, the identification device 24 includes the image sensor 24-01 and optical fiber sensor 24-02, image sensor 24-01 completes optical image information sensing for chopping cut materials on the first conveying belt 23-01, and converts into usable output signal, and the light coming from the block 23-01a on the conveying surface of the first conveying belt is sent into modulator through optical fiber, the function is realized by the optical fiber sensor 24-02 from the first conveyor 23-01 block on the 23-01, after the interaction of the parameters to be measured and the light entered the modulation region, the optical properties of light is changed, then through the optical fiber to the optical detector. After demodulation, parameter to be measured is given, in order to judge the chopping cut material position carried by the first conveying belt 23-01.

When feedback information of recognition device 24 is not in conformity with preset standard information, the removing device 25 can remove the chopping cut materials which is not conform to the specifications, according to the information, in the example the removing device 25 pushes the above materials off the first conveying surface 23-01 using block type; and when feedback information of recognition device 24 is in conformity with preset standard information, the removing device 25 will not make any operation.

In this embodiment, the chopping cut device 11 starts a chopping cut operation, accordingly, the chopping cut materials is compacted and falls on the first conveying belt 23-01, the materials are between the two blocks 23-01a on the conveying surface; when the chopping cut device 11 stars next chopping cut, at the same time, the first conveying belt 23-01 which carries chopping cut material moves forward for a distance, the moving distance is larger than the chopping cut material. At this time, the chopping cut material is compacted and falls on the first conveying belt 23-01, also the materials are between the next two blocks 23-01a on the conveying surface, so repeatedly for positioning and conveying.

The optical fiber sensor 24-02 is used to detect the light from two blocks 23-01a on the conveying surface of the first conveying belt 23-01, when two block between the block 23-01a load put cut material position and a compaction cut down cut the material position does not correspond, the output information will adjust the first conveyor belt 23-01 delivery position.

See FIG. 6, the optical fiber sensor 24-02 is installed on the baffle locating on the side of the first conveying belt 23-01, the first conveying 23-01 side is also provided with a correcting device 26, which includes the limit plate 26-01, the rotary rod 26-02 and correction block 26-03. The correction block 26-03 can rotary along rotary rod 26-02 for reciprocating, thus, by adjusting the position of correction block 26-03, and then limits the chopping cut materials on the first conveying belt 23-01 by precision, ready for conveying into the follow process accurately.

The removing device 25 is installed on the side of the first conveying belt 23-01, the removing device 25 includes a bracket 25-02 and a push block 25-01, the push block 25-01 can rotate on the bracket 25-02 or achieve horizontal reciprocating motion, the chopping cut materials that are not meet the specifications will be pushed out of the conveying surface of the conveying belt 23-01.

See FIG. 1 to FIG. 6, the use of in situ chopping cut cases in which the implementation of the cutting conveyor, conveying surface first cut material by in situ compaction cutting parts 11-01a compacted to a first conveying device in conveyor 23; then, using the second driving device 22 which drives the first conveying device 23 will cut the material for directional transport, in this process, the identification device 24 according to the preset information detection and recognition of cutting materials and the corresponding feedback information to the removing device 25, using the 25 remove removing device does not conform to the specifications of the cutting material; finally, the first conveyor conveying device 23 will cut the material one by one to the set position.

### EXAMPLE 2

Example 2 illustrates a common feature of the cutting mechanism of the different implementation methods, compared with the implementation of the example 1 provided in the cutting method, the implementation of the case 2 is to cut/slide cut the way to cut the material.

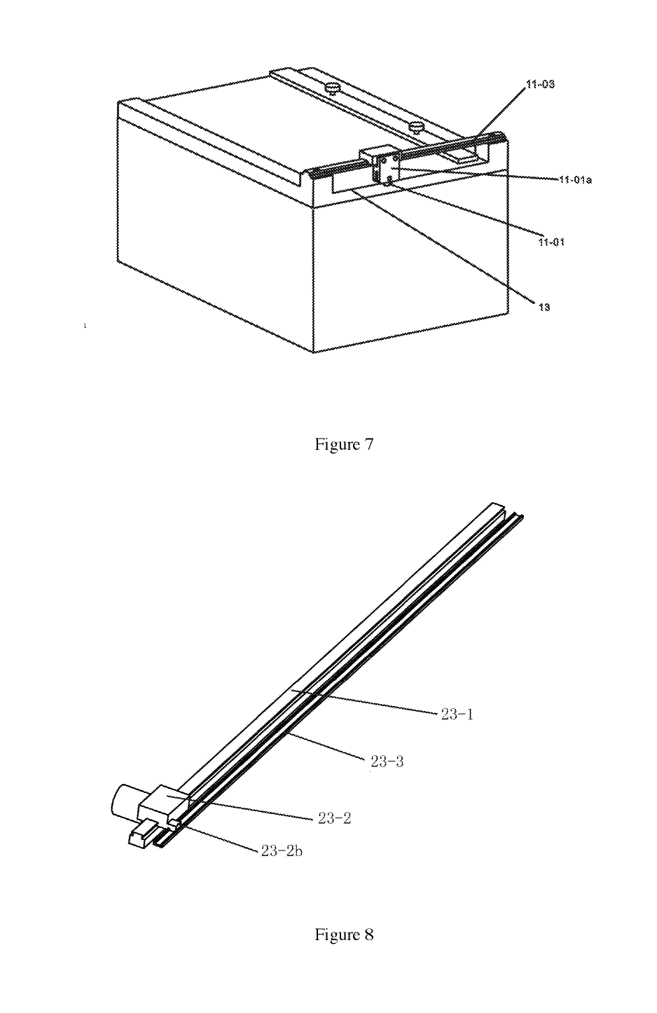

Such as shown in FIG. 7, the chopping mechanism is still set is about two limit block treat cut material limit, and knife 11-01 set on the slide rod 11-03. Knife 11-01 can in the first driving device driving role in the sliding rod about reciprocating motion.

As shown in FIG. 7, the knife 11-01 with compacting parts 11-01a. Preferably, the compacting parts 11-01a side to the material compaction to be cut, the other side to compaction roller cutting material. Specifically: knife 11-01 within the section with a material outlet 13 lower edge portion is attached, and the conveying surface of the first conveying device is just with the material outlet 13 margin of parallel, such, knife 11-01 in hobbing, compaction components 11-01a can also roll cut material compaction in the conveying surface of the first conveying device, and then transport step.

### EXAMPLE 3

An embodiment of the first conveying mechanism of different embodiments, relative to the embodiment of 1 provides the first conveying belt conveyor, example 3 is a conveying plate sliding/rolling on the material is cut.

As shown in FIG. 8, FIG. 8 shows the different embodiments of the first transmission mechanism in this embodiment, the same as the mechanism provided by the other mechanism and the embodiment 1.

See FIG. 8, the first delivery device including the rail 23-1 and slider 23-2, in this embodiment, slider 23-2 and rail 23-1 matched, in the role of the second driving device 22 to along the rail 23-1 reciprocating motion and slider 23-2 set the conveying surface 23-2a, cut the material compaction on the conveying surface 23-2a. Then through the slider 23-2 will cut material directed transport.

At the same time, the technical staff in this field can think of using the roller way to replace the sliding block 23-2, just to change the sliding mode to the rolling method, which should be included in the protection range of the present invention.

### EXAMPLE 4

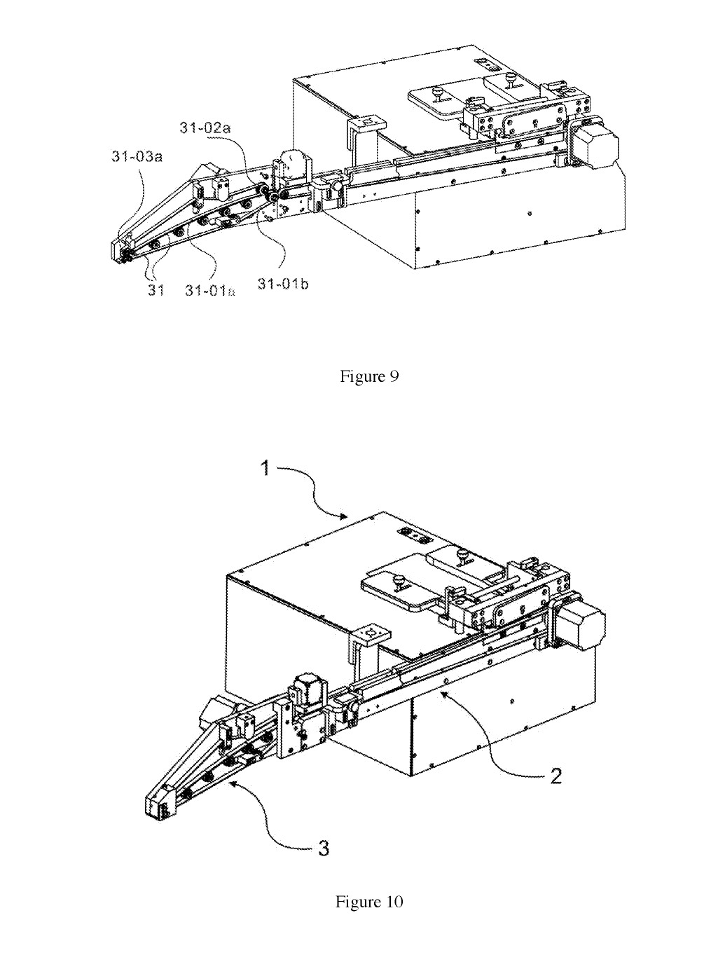

As shown in FIG. 9, FIG. 9 shows the different embodiments of the first transmission mechanism in this embodiment, the same as the mechanism provided by the other mechanism and the embodiment 1.

See FIG. 9, the first delivery device including the rail 23-1, slider 23-2 and conveying plate 23-3 match, in this embodiment, slider 23-2 and rail 23-1 matched, in under the action of the second drive device to along the rail 23-1 reciprocating motion and slider 23-2 set a small push block 23-2b, cut the material compaction on the conveying plate 23-3: and then by small push block 23-2b promote, will cut material directed transport.

At the same time, the technical staff to think that the use of the roller way to replace the slider 23-2, just the slide way to roll, should be included in the scope of the protection of embodiments of the present invention.

### EXAMPLE 5

As shown in FIG. 10, the in situ chopping cut and conveyor machine, including the implementation of the cutting mechanism 1 in the cutting mechanism 2 and the first transmission mechanism 1, in this example, the in situ chopping cut and conveyor machine also includes second transport mechanism 3.

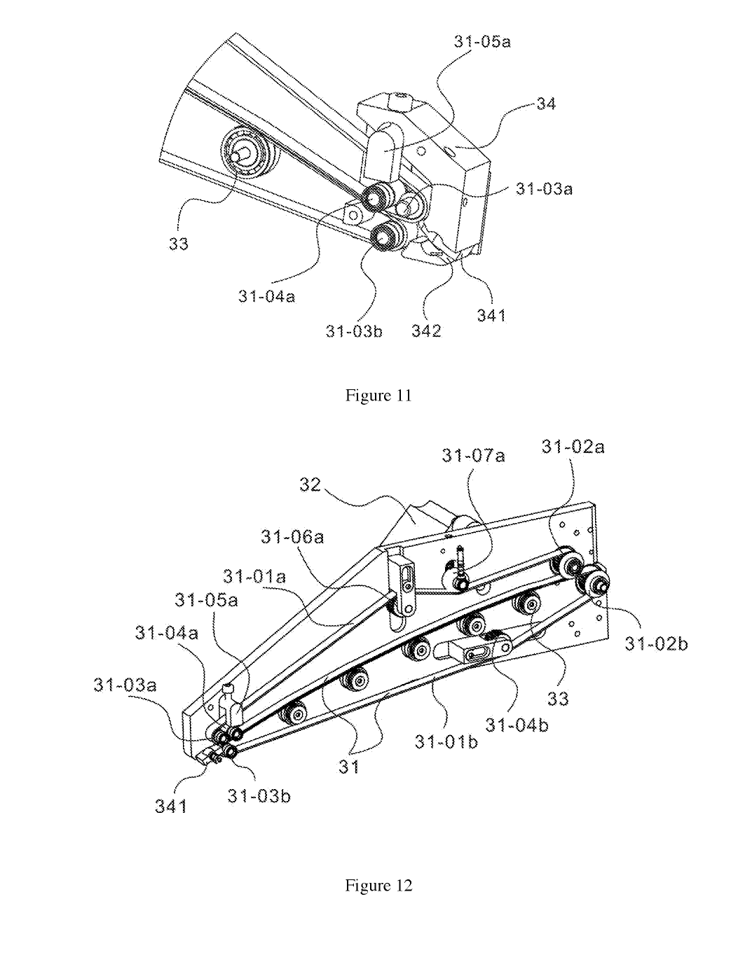

As in FIG. 11, as shown in FIG. 12, the second conveying mechanism 3 includes third driving device 32 and a second conveying device (31) and the second conveying device 31 comprises an upper conveying belt 31-01a and conveyor belt 31-01b, conveying belt 31-01a and conveyor belt 31-01b jointed, and transported with 31-01b a part of the process of the conveyor with 31-01a settings, see FIG. 12 labeled L, so as to set, is in order to better undertake the implementation of case 1 in the first transmitting device to transmit to the cut material for the parallel translation for clamping and moving. The third driving device 32 drives the upper conveying belt 31-01a and the lower conveying belt 31-01b to carry out directional movement.

A second conveying device 31 main structure is a dual structure of the conveyor belt is two conveying belt through the addition, clamping conveying strip, two conveying belt stacking surface by one group of rollers or arc surface of a round slide down tilt, and at the end of the set to of strip aided management throughout the more linear output.

A second conveying device 31 main structure is a dual structure of the conveyor belt is two conveying belt through the addition, clamping conveying strip, two conveying belt stacking surface by one group of rollers or arc surface of a round slide down tilt, and at the end of the set to of strip aided management throughout the more linear output.

Conveyor belt 31-01b, by conveying belt driving wheel 31-02b drive, is arranged at the end of the conveyor belt from the wheel 31-03b, is arranged in the middle part under the conveyor tensioning wheel 31-04b. Under the conveying belt tensioner 31-04b conveyor belt tensioning.

The upper conveying belt tensioning wheel 31-06a and the lower conveying belt tension wheel 31-04b are used in the second conveying device 31, in which, the reason is the convenience of replacing the conveying belt 31-01a and the lower conveying belt 31-01b.

Conveyor belt 31-01a and conveyor belt 31-01b superimposed on the lower part is provided with a roller 33, a plurality of roller 33 along the arc settings, can let the conveying belt 31-01a and conveyor belt 31-01b partially stacked along the curved downward transport, the roller group 33 may also is an arc supporting surface.

On the conveyor belt driving wheel 31-02a in conveying belt driving wheel 31-02b left a paragraph of distance, by two elasticity of belt conveyor with of different thickness of test paper strip clamping and conveying, conveying belt from the wheel 31-03a and the lower conveying belt from wheel 31-03b is greater than the gap of maximum thickness of the strip.

Conveyor belt from in front of the wheel 31-03a a pressure regulating wheel 31-04a can under the pressure of the block 31-05a adjustment pressure on a conveyor belt 31-01a to adjust output end to output strip clamping force.

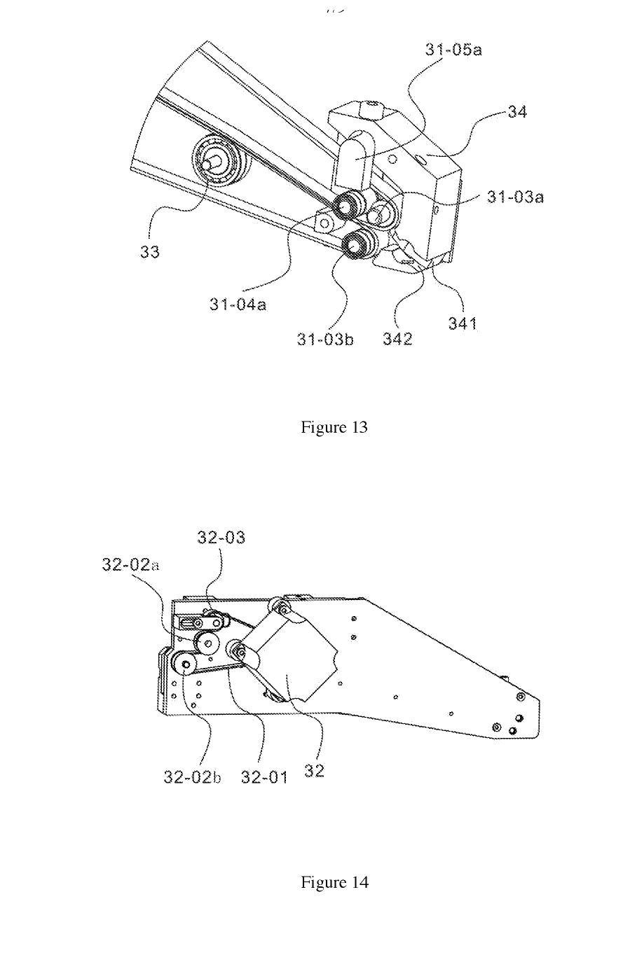

As shown in FIG. 13, the second conveying device 31 is arranged at the tail end of test paper on the output of the finishing mechanism, adjusting block 341 at the end of the finishing block 34 slit 342 can regulate the second conveying device 31 lateral position of the elastic, when the output strip elastic adjusting block in 341 strips were extrusion, so that the output is better than linear, to guarantee accuracy.

Such as shown in FIG. 14, the second conveying mechanism of the third driving device 32, also has a double-sided timing belt 32-01, driven 32-02a and 32-02b is driven, the steering is the opposite, a tension wheel 32-03 tight double-sided tooth synchronous belt 32-01, transmitted from the driving wheel 32-02a belt driving wheel 31-02a, transmitted from the drive wheel 32-02b belt driving wheel 31-02b, on the conveying belt driving wheel 31-02a and conveyor belt driving wheel 31-02b reverse rotation, dual stack surface was same to the folder to transportation of test paper strip.

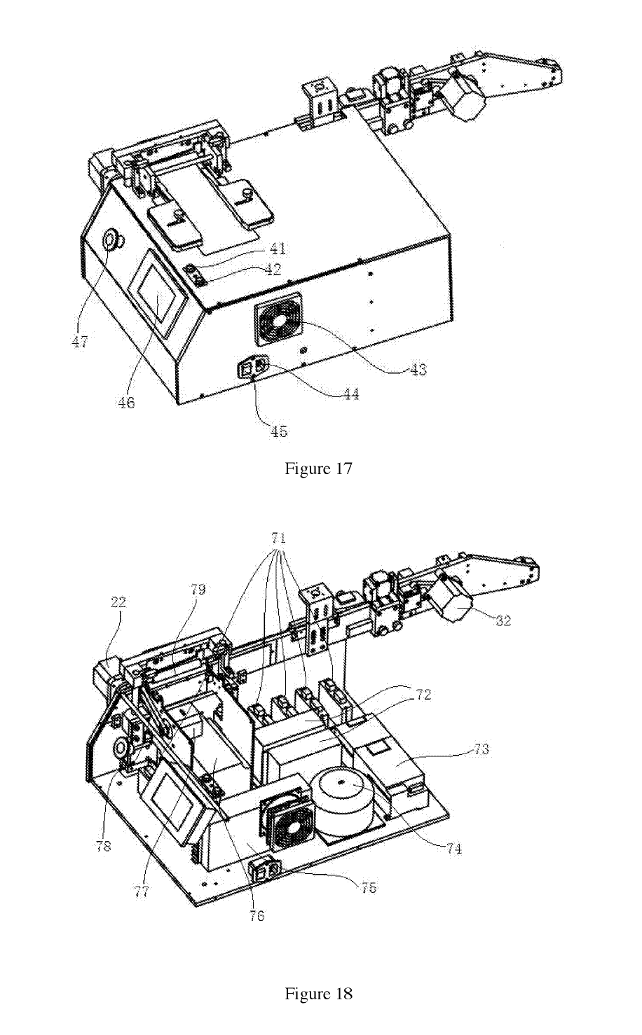

As shown in FIG. 17 and FIG. 18. Embodiment of the invention include a drive mechanism, such as shown in FIG. 17, the driving mechanism of external including start switch 41 and stop switch 42 and 43 cooling fan, power supply socket 44 and power switch 45, touch screen 46 (used to display the working status of the whole driving mechanism, you can set the parameters), emergency switch 47 (used in emergency situations, disconnect the power supply is mechanical equipment commonly used a form). As shown in FIG. 18, the drive mechanism includes a first driving device is 18 cut motor 76) and the second driving device 22 and the third driving device 32, the fourth drive device is 18 in the feed motor 77), FIG. 18 small motor driver 71 and large motor drives 72 points don't control the first driving device and the second driving device, the driving device and the driving device. The feed motor 77 is provided with a synchronous belt wheel, and the lower roller of the lower roller of the 78 driving feed roller 79 is driven by the feed synchronous belt. Cutting motor 76 through the eccentric wheel drive up and down movement of the knife, cutting material. Power line through the power supply socket 44 is connected with a power supply 75, through the transformer 74 and a power supply module, PLC 73 through control small motor drive (71) and motor drives 72 can control the movement of each motor, each motor by a separate controller control. PLC is a kind of electronic device, which is designed for the application of digital computing in the industrial environment. It can be used in the program memory, used to implement logic operation, order of operations, timing, counting and arithmetic operations, such as operating instructions in its internal memory and through digital or analog input and output, control various types of machinery or production process.

See FIG. 1 and FIG. 10-14, for the usage of in situ chopping cut and conveyor machine, first the materials for chopping cut is compacted to the surface of the first conveying belt 23 through compacting components 11-01a of the in situ chopping cut and conveyor machine; then, the second driving device 22 drives the first conveying device 23, realizes directional conveying of materials, in this process, the recognition device 24 detects and identifies the materials and feedbacks information to removing device 25, the removing device is used for removing materials that not meets the specifications ; then the third driving device 32 drives the material which is clamped by the upper conveying belt 31-01a and the lower conveying belt 31-01b for directional movement; finally, the second conveying device 31 conveyed material to be cut one by one to the set position.

At the same time, for example 5, the substitution and recombination of the example 2-4 as well as the substitution of the same are regarded as the protection scope of embodiments of the invention.

In summary, embodiments of the present invention, based on research of how to realize accurate positioning of materials for chopping cut, has creatively designed the compaction and directional conveying device. The using range of the invention lies in, the width of materials and surface roughness on the materials are no longer the main limiting factors, the materials for chopping cut are conveyed along clamping inclined angle by the conveying belt, with one-way movement, there is no repetitive movements of the manipulator, can greatly improve the working efficiency.

It should be noted that, above implementation examples are only used to illustrate the technical scheme of embodiments of the invention rather than limit it, although the referring preferred implementation examples are described in detail, the general technical personnel in the field should understand, modify or equivalent replacement of the technical scheme of embodiments of the invention without departing from the spirit and scope of the technical scheme of embodiments of the invention, which shall be covered in the claims section.

Having described some embodiments of the invention, additional embodiments will become apparent to those skilled in the art to which it pertains. While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention.

1. An in situ chopping cut and conveyor machine, comprising,
a chopping cut mechanism, wherein the chopping cut mechanism comprises a first driving device and a chopping cut device, the chopping cut device comprises an upper blade, and the first driving device drives the upper blade to carry out reciprocating motion,
the upper blade having a compaction component and the compaction component comprises a compaction part which is not lower than the upper blade edge line;
a first conveying mechanism, wherein the first conveying mechanism comprises:
a second driving device and a first conveying device, the second driving device drives the first conveying device for directional transport, the first conveying device is located below the upper blade.

2. The in situ chopping cut and conveyor machine of claim 1, further comprising a material outlet installed on the chopping cut mechanism, a lower edge of the material outlet is parallel to an inner section of the upper blade the upper blade is fit with the lower edge during the chopping cut process.

3. The in situ chopping cut and conveyor machine of claim 1, wherein
the chopping cut mechanism comprises a feed device,
the feed device includes an upper feed roller and lower feed roller, the lower feed roller is driven by a fourth driving device, the upper feed roller is installed on a turning frame, the upper feed roller rotatively coupled to the lower feed roller;
the feed device further comprises two limiting blocks to limit material to be cut, the chopping cut device allows for the material to be prepped for accurate chopping cut by the chopping cut device through fitting the material between the upper feed roller and the lower feed roller.

4. The in situ chopping cut and conveyor machine of claim 2, wherein
the first conveying device comprising a first conveyor belt, the first conveyor belt is installed on the lower edge side of the material outlet, and a conveying surface of the first conveyor belt is not higher than the lower edge.

5. The in situ chopping cut and conveyor machine of claim 4, wherein the conveying surface of the first conveyor belt is installed via a plurality of blocks, the interval of the blocks is larger than a length of the materials for chopping.

6. The in situ chopping cut and conveyor machine of claim 5, wherein a recognition device is installed on a side of the first conveyor belt, the recognition device configured to preset detection and recognition for cutting materials and provide corresponding feedback information,
the recognition device includes an image sensor, the image sensor generates optical image information for materials to be cut on the first conveyor belt and converts the optical image information into an output signal, the recognition device comprises a fiber optic sensor, the fiber optic sensor is installed on the side of first conveyor belt the fiber optic sensor transmits light from the block on the surface of the first conveyor belt into a modulator through an optical fiber, the parameters to be measured correspond with the light entered into a modulation region of the modulator, wherein further changes in the optical properties of the light occur in response to transmission to the optical detector through the optical fiber,
wherein after demodulation, measured parameters determine a position of material on the first conveying belt to be cut.

7. The in situ chopping cut and conveyor machine of claim 6, further comprising a removing device installed on the side of the first conveying belt, the removing device subsequently positioned relative the recognition device, wherein according to corresponding feedback of information from the recognition device the materials to be cut can be removed.

8. The in situ chopping cut and conveyor machine of claim 1, further comprising a correcting device installed on the side of the first conveyor belt,
the correcting device includes limiting plate, rotary rod and correction block, the correction block configured to reciprocate on the rotary rod.

9. An in situ chopping cut and conveyor machine of claim 1, further comprising:
a second conveying mechanism,
the second conveying mechanism installed at an end of the first conveying mechanism, the second conveying mechanism comprises a third driving device and a second conveying device the second conveying device comprises an upper conveying belt and a lower conveyor belt the upper conveying belt is coupled to the lower conveyor belt,
the third driving device drives the upper conveying belt and the lower conveying belt to realize directional movement.

10. The in situ chopping cut and conveyor machine of claim 9, wherein the lower conveyor belt is at least partially coupled to the upper conveying belt, a portion of the lower conveyor belt is anterior relative the setting of the upper conveying belt.

11. The in situ chopping cut and conveyor machine of claim 9, wherein the upper conveying belt is driven by a first driving pulley disposed at an end of the upper conveying belt, a middle part of the upper conveying belt is provided with an upper conveying belt tension pulley and an upper conveying belt elastic pulley, the lower conveyor belt is driven by a second driving pulley disposed at an end of the lower conveying belt, a middle part of the lower conveyor belt is provided with a lower conveying belt tension pulley, the first driving pulley for the upper conveying belt is on the left side of the second driving pulley for the lower conveying belt and keeps a distance, a test paper strip with different thickness can be clamped, there is a gap larger than the largest thickness test paper strip; an adjustable pressure pulley installed in front of the first driving pulley for the upper conveying belt; a pressing block configured to be pressed such that, pressure to the upper conveying belt can be adjusted as well as, pressure of the lower conveying belt such that, a clamping force of outputting end and test paper strip can be adjusted during outputting process.

12. The in situ chopping cut and conveyor machine of claim 11, further comprising a roller installed on the lower stacked part of the upper conveying belt and the lower conveying belt, multiple rollers arranged along an arc o a stacked part of the upper conveying belt and the lower conveying belt are configured to be conveyed downward along the arc.

13. The in situ chopping cut and conveyor machine of claim 9, further comprising: a finishing mechanism for outputting test paper strip device installed at an end of the second conveying device;
an elastic adjusting block to adjust lateral position with the second conveying device at a slit of an end finishing block, wherein the elastic adjusting block is flexible,
wherein in response to the test paper being outputs, the elastic adjusting block is configured to extrude the test paper strip to ensure that the assemblage of test paper strip is accurate.

14. The in situ chopping cut and conveyor machine of claim 9, wherein the third driving device of the second conveying mechanism, further comprises a double-sided tooth synchronous belt, a first driving pulley and a second driving pulley are rotatively driven in opposite direction, the tensioning pulley tensions the double-sided tooth synchronous belt, the first driving pulley drives the upper conveyor belt drive pulley and the second driving pulley drives the lower conveyor belt drive pulley.

15. The in situ chopping cut and conveyor machine of claim 1, wherein the upper blade is arranged on an expansion bracket, wherein at least one of (1) a drive of the first drive device and the upper blade completes the chopping cut with up and down reciprocating motion, and (2) the upper blade arranged on the slide rod is driven by the first drive device, the upper blade completes the chopping cut with up and down reciprocating motion on the slide rod.

16. The in situ chopping cut and conveyor machine of claim 1, wherein the first conveying device includes a rail, a slide block, and a conveying plate, the slide block coupled to the rail and under the action of the second driving device, wherein the side block is configured to reciprocate along the rail, the slide block is provided with a small push block, the chopping cut material is compacted on the conveying plate, and then through a small push block to carry out directional conveying of the clamped chopping cut material.

17. (canceled)

18. A method of using an in situ chopping cut and conveyor machine to cut, locate, and convey material, the method comprising:
compacting the material to be cut at a conveyor surface of a first conveying device through a compacting component of the in situ cut and conveyor machine;
driving the first conveying device by the second driving device to carry out directional conveying of the clamped and cut material; and
conveying the cut material one by one to a setting location.

19. The method of claim 18, further comprising: detecting and identifying the materials for being cut, wherein based on the detecting and identifying of the material by a recognition device, a removing device is configured to remove the material that does not meet a defined specification.

20. The method of claim 18 further comprising:
driving the upper conveying belt (31-01a) and the lower conveying belt by a third driving device to carry out the directional movement of the cut material.

21. (canceled)
